(19) United States
(12) Patent Application Publication
(10) Pub. No.: US 2015/0020843 A1
(43) Pub. Date: Jan. 22, 2015

(54) ADVANCED TOOTHPICK

(71) Applicant: MIN SUNG PRECISION CO., LTD., Bucheon-si (KR)

(72) Inventor: Young Se KIM, Seoul (KR)

(73) Assignee: MIN SUNG PRECISION CO., LTD., Bucheon-si (KR)

(21) Appl. No.: 14/329,849

(22) Filed: Jul. 11, 2014

(30) Foreign Application Priority Data
Jul. 22, 2013 (KR) 20-2013-0006095

(51) Int. Cl. A61C 15/02; A46B 15/00; A61C 15/04

(52) U.S. Cl. CPC A61C 15/02; A61C 15/046; A46B 15/0069
USPC 132/309; 132/329; 132/323

(57) ABSTRACT

Disclosed is a toothpick which enables a user to effectively remove foreign matters between teeth, to easily remove plaque or scale from a tooth, and to simply carry the toothpick, so that the user can more improve the health of teeth. The toothpick includes a body, a bending part provided at one end of the body and having a shape sharpened toward an end thereof such that at least a portion of the bending part is inserted between teeth, and an unevenness part provided at an opposite end of the body, having a flat shape, having at least a portion inserted between the teeth, and having a plurality of protrusions formed on a surface thereof to remove at least one of plaque and scale from a tooth. The bending part has a bent shape to remove foreign matters between the teeth inside an oral cavity through the bent shape.

### BACKGROUND OF THE INVENTION

1. Field of the Invention

The present invention relates to a toothpick which enables a user to effectively remove foreign matters between teeth, to easily remove plaque or scale from a tooth, and to simply carry the toothpick, so that the user can more improve the health of teeth.

2. Description of the Related Art

In general, a toothpick has been used to remove foreign matters between teeth. The toothpick is typically made of plastic or wood. Recently, a starch toothpick, which is decomposable, has been extensively used by taking into consideration environmental pollution.

Recently, with the advance of eating out culture according to the improvement in the standard of living, a toothpick has been used instead of the brushing of teeth with a toothbrush in order to more simply manage dental hygiene.

In addition, as dental health is lately emphasized again, the toothpick is spotlighted as an essential product in eating to clean teeth and maintain the dental hygiene, so that hundreds of thousands of toothpicks have been consumed.

In addition, in the case of a dental toothbrush made of wire and wool, since the wire may be easily bent or broken only by several uses of the dental toothbrush, the dental toothbrush is uneconomical for the price thereof. Further, dental floss is inconvenient for a user or annoys the user in the use thereof. In addition, the user may put a dirty finger into a mouth in order to use the dental floss, which makes the user feel unhygienic. Accordingly, persons may avoid using the dental floss.

In general, the toothpick has a sharpened portion at one end thereof or both ends thereof. In the state that the sharpened portion of the toothpick is placed between teeth, the toothpick is vertically moved to remove the foreign matters, such as food debris, between teeth.

However, the toothpick according to the related art has a straight-line shape, so that the toothpick may not effectively remove foreign matters inside an oral cavity or between morals.

If the foreign matters inside the oral cavity or at a deep position between the morals are not completely removed, but are neglected for a long time, not only is scale produced, but also bacteria are grown to cause bad breath and damage to gums.

In addition, if the toothpick is forcedly used to remove the foreign matters inside the oral cavity or between morals, the interval between teeth may be gradually widened to cause damage to the gums.

The erroneous use of the toothpick may damage the root of a tooth, thereby causing bleeding or gum disease.

Further, if the typical toothpick according to the related art is used, the foreign matters between teeth may be removed to some extent. However, the toothpick cannot be precisely pushed between the teeth differently from dental floss or an inter-dental brush, and the toothpick may not remove plaque or scale from the teeth.

Therefore, the development of a toothpick capable of simply and effectively cleaning oral cavity is required. Examples of the toothpick are disclosed in Korean Unexamined Patent Publication No. 10-2010-0116024 and Korean Unexamined Utility Model No. 20-2011-0006662.

### SUMMARY OF THE INVENTION

Accordingly, the present invention has been made keeping in mind the above problems occurring in the prior art, and an object of the present invention is to provide a toothpick which enables a user to effectively remove foreign matters between teeth, to easily remove plaque or scale formed on a tooth, and to provide portability to improve the health of teeth and gums.

Another object of the present invention is to provide a toothpick which enables a user to effectively remove foreign matters inside an oral cavity or on a molar through a bent shape thereof and to effectively remove plaque or scale by using protrusions formed on a surface of the toothpick.

Still another object of the present invention is to provide a toothpick which enables a user to maintain clean teeth while the user simply carries the toothpick by detachably attaching a tooth managing unit suitable for the purpose of the user if necessary.

In other to accomplish the above objects of the present invention, there is provided a toothpick including a body, a bending part provided at one end of the body and having a shape sharpened toward an end thereof such that at least a portion of the bending part is inserted between teeth, and an unevenness part provided at an opposite end of the body, having a flat shape, having at least a portion inserted between the teeth, and having a plurality of protrusions formed on a surface thereof to remove at least one of plaque and scale from the tooth. The bending part has a bent shape to remove foreign matters between the teeth inside an oral cavity by the bent shape.

In addition, at least one of the bending part and the unevenness part may include an elastic material and are bendable.

Further, the toothpick may further include a coupling part located between the body and the unevenness part and detachably coupled with at least one of the body and the unevenness.

Further, the toothpick may further include a plurality of protrusions formed on a surface of at least one of the body and the coupling part to allow a user to grip the at least one of the body and the coupling part.

In addition, the toothpick may additionally include a dental floss part provided at end portions thereof with branches to form a dental floss groove in a U shape and having a dental floss fixed thereto and crossing the dental floss groove. The dental floss part may be coupled with the coupling part if the body or the unevenness part is decoupled.

The dental floss may have a thin film containing peppermint flavor.

The toothpick may further include a plurality of brushes formed at an end portion of the bending part to help the toothpick to remove the foreign matters.

As described above, according to the present invention, the toothpick enables the user to effectively remove foreign matters between teeth, to easily remove plaque or scale formed on a tooth, and to provide portability to improve the health of teeth and gums.

In detail, the toothpick enables the user to effectively remove foreign matters inside an oral cavity or on a molar through a bent shape thereof and to effectively remove plaque or scale by using protrusions formed on a surface of the toothpick.

Further, the toothpick enables the user to maintain clean teeth while the user simply carry the toothpick by detachably attaching a tooth managing unit suitable for the purpose of the user if necessary.

Meanwhile, other than the above effects, the present invention has various effects that can be deduced from the following detailed description, which can be clearly understood by those skilled in the art.

### BRIEF DESCRIPTION OF THE DRAWINGS

FIG. 1 is a view showing a shape of a typical toothpick according to the related art.

FIGS. 2a and 2b are front and plane views showing a toothpick according to one embodiment of the present invention.

FIGS. 3a and 3b are views showing one example of a dental floss part applicable to the toothpick according to the present invention.

FIG. 4 is a view showing an example that the dental floss part is coupled with the toothpick according to the present invention.

### DETAILED DESCRIPTION OF THE INVENTION

Hereinafter, an example embodiment of the present invention will be described with reference to accompanying drawings. In addition, one embodiment described in the following description does not limit the scope of the present invention, and all components described in the present embodiment are not essential components in the present invention.

In general, a toothpick is extensively used for a clean tooth and dental hygiene in our daily lives, and one of manners enabling a user to conveniently and rapidly manage the dental hygiene.

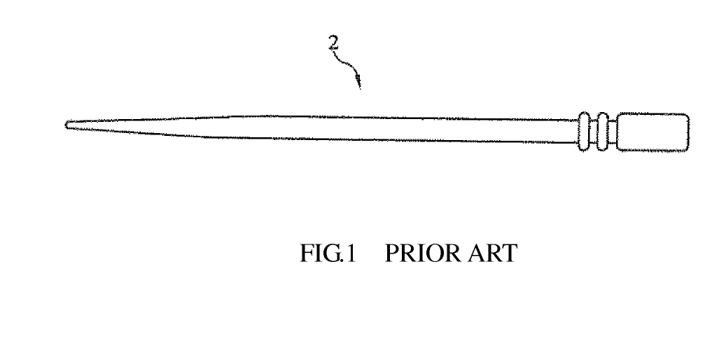

FIG. 1 is a view showing a shape of a typical toothpick according to the related art.

As shown in FIG. 1, a toothpick 2 according to the related art is provided in the shape of a long straight rod, and provided at an end portion thereof with a tip part allowing a user to insert the tip part between teeth in order to remove food debris or residues between the teeth.

However, the straight-type toothpick may not reach an inner part of an oral cavity or a molar so that the management for a clean tooth may be difficult, which may cause decayed teeth or dental disease.

In addition, the toothpick according to the related art may be effectively used only in removing foreign matters from teeth and has a difficulty in removing plaque or scale from the teeth, so that there is a limitation in maintaining clean teeth.

Therefore, the present invention suggests a toothpick capable of simply and efficiently improving dental health.

Hereinafter, a toothpick according to the present invention will be described in detail.

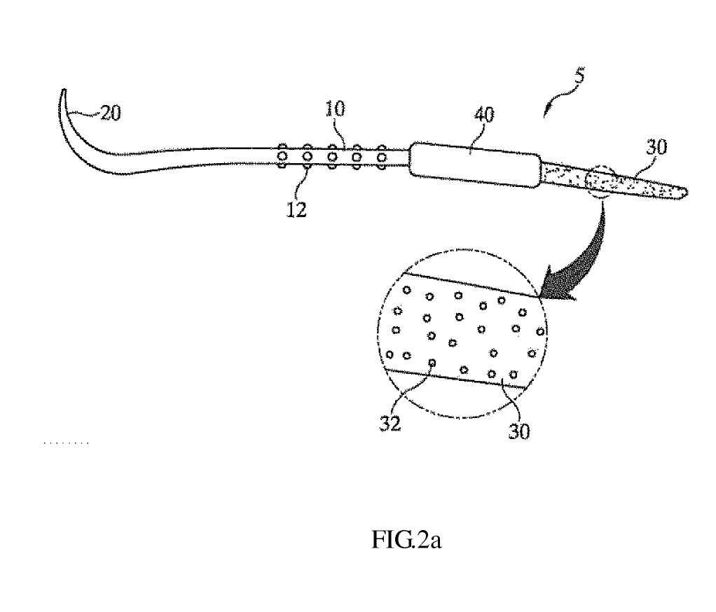

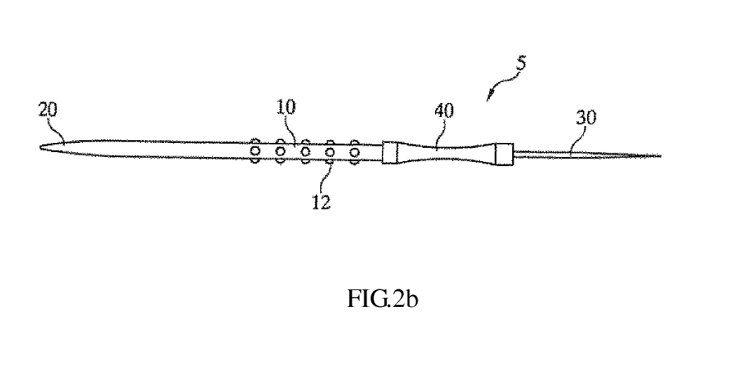

FIGS. 2a and 2b are front and plane views showing a toothpick according to one embodiment of the present invention.

Referring to FIGS. 2a and 2b, a toothpick 5 according to the present invention may include a body 10, a bending part 20, an unevenness part 30, and a coupling part 40. However, since the components shown in FIGS. 2a and 2b are not essential, the present invention may include a larger number of components or a smaller number of components.

Hereinafter, the above components will be sequentially described.

The body 10 is provided in the shape of a rod having a long length in a longitudinal direction thereof, and serves as a handle gripped by a user hand. In particular, the body 10 has a thick intermediate portion for the convenient grip so that a user can easily apply force to the toothpick with fingers.

The body 10 is provided at one end thereof with the bending part 10, and provided at an opposite end thereof with the coupling part 40. The unevenness part 30 is coupled with the body 10 through the coupling part 40.

In addition, since the body 10 is gently inclined upward, the toothpick may be slantly inserted into teeth inside an oral cavity to efficiently remove foreign matters between the teeth.

The body 10 may be provided on the surface thereof with a plurality of protrusions 12 including rubber so that the body 10 can be conveniently gripped by fingers without being slipped. Alternatively, the intermediate portion of the body 10 may be flat for the stable grip by the fingers.

The body 10 may include a generally-known plastic material, such as poly propylene or poly ethylene.

Meanwhile, the bending part 20 may be formed integrally with the body 10. The bending part 20 may be sharpened toward an end portion thereof, and may have a triangular section so that the bending part 20 may be inserted between teeth.

The bending part 20 may have a space therein, so that the thickness of the bending part 20 may be changed by external force when the toothpick 5 according to the present invention is used. In other words, if a user puts the bending part 20 of the toothpick 5 between teeth having a narrow interval, the inner space of the bending part 20 is pressed, so that the thickness of the bending part 20 may be changed.

Accordingly, the toothpick 5 can effectively remove foreign matters, such as food debris, even between teeth having the narrow interval without damage to gums.

In the bending part 20 of the toothpick 5, a partial section of the end portion thereof, for example a section, which is about 5 mm distanced from the tip of the end portion thereof, has a solid triangular section allowing the bending part 20 to be easily inserted in the initial stage.

In addition, the bending part 20 may have a bent shape with a curved line. The bending part 20 has a structure appropriate to removing foreign matters between teeth located at a depth position in the oral cavity that the straight type toothpick is difficult to approach.

In other words, the bending part 20 is slantly formed so that the bending part 20 can easily access a space between teeth, such as moral teeth, located in the oral cavity in the state that the user holds the body 10 with a hand, thereby efficiently removing the foreign matters provided at an inner part of the oral cavity or the moral tooth.

The bending part 20 may include an elastic material so that the bending part 20 may be elastically bent to both sides and returned like a spring.

Accordingly, when the bending part 20 may be inserted between teeth irregularly bent, the bending part 20 may be flexibly bent.

In addition, the bending part 20 can prevent the interval between teeth from being widened and prevent teeth and gums from being damaged.

In particular, when a typical toothpick is inserted between the moral teeth, an insertion angle is not desirable, so that the toothpick may be forcedly inserted. Accordingly, the toothpick according to the present invention can solve the above problem.

In addition, a plurality of brushes may be formed on an end portion of the bending part 20, so that the foreign matters, such as food debris, between teeth may be removed due to contact force through the brushing operation.

The brush includes an elastic material to prevent gums or teeth from being damaged, and the length of the brush is gradually shortened toward the end portion of the bending part 20.

Meanwhile, the unevenness part 30 may have a flat shape to solve the problem of widening the interval between teeth as the rod-shape toothpick according to the related art is forcedly pushed between the teeth. In addition, the unevenness part 30 has elasticity so that the unevenness part 30 is not easily broken to protect teeth or gums.

The unevenness part 30 has the size and the thickness sufficient to be inserted between teeth. The unevenness part 30 may remove the foreign matters such as food debris between teeth without damage to gums, and may have a function of massaging the gums.

In addition, the unevenness part 30 may be provided on the surface thereof with a protrusion 32, and the protrusion 32 may include rubber. The protrusion 32 may include a plurality of protrusions, and plaque or scale may be removed from teeth by using the protrusions 32.

In addition, the unevenness part 30 may include an elastic material so that the unevenness part 30 may be elastically bent to both sides and returned like a spring.

Accordingly, when the unevenness part 30 may be inserted between teeth irregularly bent, the unevenness part 30 may be flexibly bent. In addition, the unevenness part 30 can prevent the interval between teeth from being widened and prevent teeth and gums from being damaged.

Meanwhile, the coupling part 40 may couple the body 10 with the unevenness part 30, or may release the coupling between the body 10 and the unevenness part 30 so that the body 10 can be decoupled from the unevenness part 30.

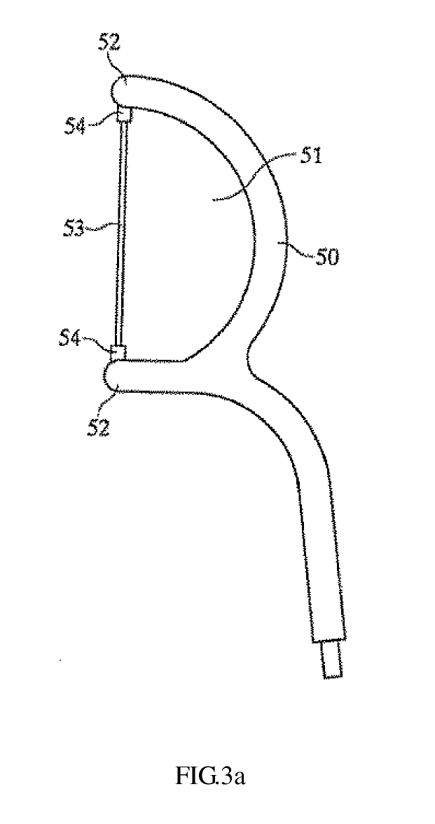

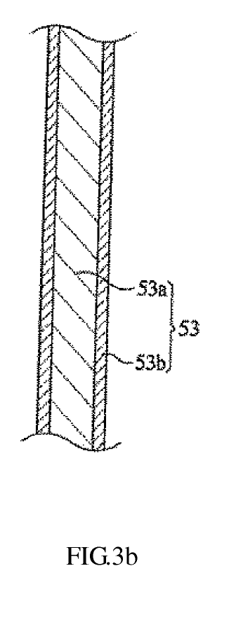

For example, the coupling part 40 is provided at both inner surfaces thereof with female screws, and male screws may be formed at ends of the body 10, the unevenness part 30, and the tooth floss part 50 shown in FIG. 3a.

The female screw of the coupling part 40 and one of the male screws may be rotated clockwise or counterclockwise for the coupling therebetween. After the coupling therebetween has been finished, the female screw and the one of the male screws are rotated in an opposite direction so that the female screw may be decoupled from the one of the male screws.

According to another example, the coupling part 40 may be provided at both inner surfaces thereof with concave grooves, and convex engaging parts may be formed at one end portions of the body 10, the unevenness part 30, and a dental floss part 50. One of the convex engaging parts is inserted into the groove formed in the coupling part 40, so that the convex engaging part may be coupled with the groove formed in the coupling part 40.

In order to firmly couple the convex engaging part with the groove, the concave groove may have fixing protrusions protruding outward, and the convex engaging parts may have concave protrusions having shapes corresponding to the shapes of the fixing protrusions. When the engaging part is inserted into the concave groove formed in the coupling part 40, since the fixing protrusion is mutually engaged with the convex protrusion, so that the engaging part can be firmly coupled with the concave groove.

In addition, a plurality of protrusions 12 may be formed on the surface of the body 10, so that fingers of the user can conveniently grip the body 10 without being slipped.

Meanwhile, the toothpick 5 according to the present invention may be made through injection molding performed by injecting a synthetic resin source material into a mold. When the toothpick 5 is made of the synthetic resin source material, the toothpick 5 has proper elastic force to prevent pain when the toothpick 5 makes contact with the gums of the user. In addition, the toothpick 5 can be cleaned and reused without being discarded after the toothpick 5 is used once.

In addition, the toothpick 5 according to the present invention is designed suitably for the oral cavity in a simple structure, so that the failure of the toothpick 5 is difficult. Further, the toothpick 5 can be easily used and produced at a low price, and can be used several times.

Hereinafter, the modification of the toothpick according to the present invention will be described.

FIGS. 3a and 3b show one example of the dental floss part 50 applicable to the toothpick according to the present invention. Referring to FIG. 3a, the dental floss part 50 may include a dental floss groove 51, branches 52, a dental floss 53, and cams 54.

The dental floss part 50 has the branches 52 to form the dental floss groove 51 having a U shape, and the dental floss 53 to cross the dental floss groove 51 is fixed on the branches 52.

As shown in FIG. 3a, a pair of branches 52 are spaced apart from each other by a predetermined distance. The branches 52 are provided in the end portions thereof with grooves used to insert the dental floss 53 and the cams 54 to fix the inserted dental floss 53.

A coupling unit is formed at an end portion of the dental floss part 50 provided in opposition to the dental floss groove 51 so that the coupling unit may be coupled with or decoupled from the coupling part 40.

Referring to FIG. 3b, the dental floss 53 applicable to the dental floss part 50 according to the present invention may include a yarn fiber 53a and a film part 53b.

The yarn fiber 53a may selectively include silk or nylon that represents strong tensile force or a soft property.

The film part 53b contains peppermint flavor, which is a kind of mint flavor, extracted from peppermint leaves that belong to herbal plants. The peppermint flavor clears the cobwebs from the brain of a user and calms the nerves of the user. The peppermint flavor allows the user to feel refreshed in the mouth of the user and sterilizes the mouth of the user to prevent the teeth of the user from being decayed.

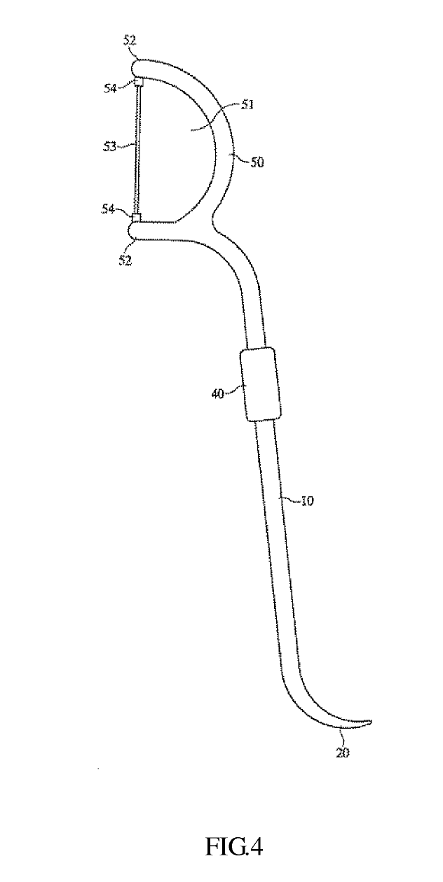

FIG. 4 is a view showing an example that the dental floss part is coupled with the toothpick according to the present invention.

The coupling part 40 of the toothpick 5 according to the present invention may couple the body 10 with the unevenness part 30. One of the body 10 and the unevenness part 30 may be decoupled from the assembly, and the dental floss part 50 shown in FIG. 3a may be coupled with the assembly in place of the one of the body 10 and the unevenness part 30 for the use of the dental floss part 50.

FIG. 4 shows an embodiment of the present invention in which the unevenness part 30 is decoupled from the coupling part 40, and the dental floss part 50 is coupled with the coupling part 40 in place of the unevenness part 30.

Various units to manage dental hygiene may be employed depending on the needs and the tendency of the user. If the user wants to use the dental floss instead of the unevenness part 30, the unevenness part 30 may be decoupled from the coupling part 40 and the dental floss part 50 may be coupled with the coupling part 40 as shown in FIG. 4.

Similarly, if the user wants to use a dental floss instead of the bending part 20 in order to manage the dental hygiene, the bending part 20 is decoupled from the coupling part 40, and the dental floss part 50 is coupled with the coupling part 40 in place of the bending part 20 so that both of the dental floss part 50 and the unevenness part 30 may be used.

As described above, the user may select a tooth managing unit according to the requirement of the user and may couple the tooth managing unit. The user may simply carry the tooth managing unit to easily remove the foreign matters from the teeth, so that the dental hygiene can be effectively improved.

As described above, according to the toothpick of the present invention, the dental hygiene at the depth position inside oral cavity can be more effectively managed, plaque or scale can be removed, and various dental hygiene managing units can be selectively used, so that dental health can be effectively and simply improved. In addition, both of the dental floss part and the unevenness part are provided in the toothpick, so that the use of the dental floss part or the unevenness part can be induced. Therefore, oral health can be more improved.

The above apparatus is not limited to the above described components in the embodiments described above, and the embodiments may be partially or totally combined with each other for the various modifications of the embodiments.

What is claimed is:

1. A toothpick comprising:
a body;
a bending part provided at one end of the body and having a shape sharpened toward an end thereof such that at least a portion of the bending part is inserted between teeth; and
an unevenness part provided at an opposite end of the body, having a flat shape, having at least a portion inserted between the teeth, and having a plurality of protrusions formed on a surface thereof to remove at least one of plaque and scale from a tooth,
wherein the bending part has a hook shape to remove foreign matters between the teeth inside an oral cavity through the bent shape.

2. The toothpick of claim 1, wherein at least one of the bending part and the unevenness part includes an elastic material so as to be bent.

3. The toothpick of claim 1, further comprising a coupling part located between the body and the unevenness part and detachably coupled with at least one of the body and the unevenness part.

4. The toothpick of claim 3, further comprising a plurality of protrusions formed on a surface of at least one of the body and the coupling part to allow a user to grip the at least one of the body and the coupling part.

5. The toothpick of claim 3, further comprising a dental floss part provided at end portions thereof with branches to form a dental floss groove in a U shape and having a dental floss fixed thereto and crossing the dental floss groove, wherein the dental floss part is coupled with the coupling part if the body or the unevenness part is decoupled.

6. The toothpick of claim 5, wherein the dental floss has a thin film containing peppermint flavor.

7. The toothpick of claim 1, further comprising a plurality of brushes formed at an end portion of the bending part to assist removal of the foreign matters.
